(19) United States
(12) Patent Application Publication
(10) Pub. No.: US 2003/0227979 A1
(43) Pub. Date: Dec. 11, 2003

(54) Method and arrangement for digital signal transmission

(76) Inventor: Olav Tirkkonen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/378,068

(22) Filed: Mar. 4, 2003

Related U.S. Application Data
(63) Continuation of application No. PCT/FI00/00916, filed on Oct. 23, 2000.

(30) Foreign Application Priority Data
Sep. 4, 2000 (FI) 20001944

(51) Int. Cl. H04L 1/02; H04B 7/02

(52) U.S. Cl. 375/267

(57) ABSTRACT

The invention relates to a method and an arrangement for transmitting a digital signal consisting of symbols, the arrangement comprising a coder at the transmission end for coding complex symbols to channel symbols in blocks of given length, wherein the coding is defined by a code matrix comprising an orthogonal block code, and a transmitter for transmitting the channel symbols via several different channels and two or more antennas. The arrangement is configured to include information in redundant directions of the orthogonal code such that a code rate is higher than what is allowed by orthogonality.

This application is a Continuation of International Application PCT/FI00/00916 filed on Oct. 23, 2000, which designated the U.S. and was published under PCT Article 21(2) in English.

### FIELD OF THE INVENTION

The invention relates to a method and a radio system for transmitting a digital signal in a radio system, particularly in a mobile communication system. In particular the invention relates to the use of transmit diversity.

### BACKGROUND OF THE INVENTION

In telecommunication connections, the transmission path used for transmitting signals is known to cause interference to telecommunication. This occurs regardless of the physical form of the transmission path, i.e. whether the transmission path is a radio link, an optical fibre or a copper cable. Particularly in radio telecommunication there are frequently situations where the quality of the transmission path varies from one occasion to another and also during a connection.

Radio path fading is a typical phenomenon that causes changes in a transmission channel. Other simultaneous connections may also cause interferences and they can vary as a function of time and place.

In a typical radio telecommunication environment the signals between a transmitter and a receiver propagate on a plurality of routes. This multipath propagation mainly results from signal reflections from surrounding surfaces. The signals that propagated via different routes reach the receiver at different times due to different propagation time delays. Various methods have been developed in order to compensate the fading caused by this multipath propagation.

One solution to the problem is the use of diversity at the transmission end of the connection. In time diversity, interleaving and coding are used, which cause temporal diversity to a signal to be transmitted. There is a disadvantage, however, that there will be delays in the transmission, especially when it deals with a slowly fading channel. In frequency diversity, on the other hand, a signal is transmitted simultaneously at different frequencies. This is, however, an ineffective method when the coherence bandwidth of the channel is great.

In antenna diversity the same signal is transmitted to a receiver by using two or more antennas. In this case, signal components that have multipath-propagated through different channels will probably not be disturbed by the simultaneous fading.

The publication WO 99/14871 discloses a diversity method in which the symbols to be transmitted, consisting of bits, are coded in blocks of given length and in which each block is coded to a given number of channel symbols to be transmitted via two antennas. A different signal is transmitted via each antenna. For example, when the symbols to be coded are divided into blocks having the length of two bits, the channel symbols to be transmitted are formed such that the channel symbols to be transmitted via the first antenna consist of a first symbol and a complex conjugate of a second symbol, and the channel symbols to be transmitted via the second antenna consist of the second symbol and a complex conjugate of the first symbol. The described solution is, however, only applicable when two antennas are used. The solution is called space-time block coding.

The publications Tarokh, V., Jafarkhani, H., Calderbank, A. R.: Space-Time Block Codes from Orthogonal Designs, IEEE Transactions on information theory, Vol. 45 pp. 1456-1467, July 1999 and Tarokh, V., Jafarkhani, H., Calderbank, A. R.: Space-Time Block Coding for Wireless Communications: Performance Results, IEEE Journal on Selected Areas In Communication, Vol. 17 pp. 451-460, March 1999, disclose corresponding solutions which can be applied to more than two antennas. As an example, the code of the code rate % is given:

$$( {z}_{1} , {z}_{2} , {z}_{3} ) -> ( \begin{matrix}{z}_{1} & {z}_{2} & \frac{{z}_{3}}{\sqrt{2}} & \frac{{z}_{3}}{\sqrt{2}} \\ - {z}_{2}^{*} & {z}_{1}^{*} & \frac{{z}_{3}}{\sqrt{2}} & - \frac{{z}_{3}}{\sqrt{2}} \\ \frac{{z}_{3}^{*}}{\sqrt{2}} & \frac{{z}_{3}^{*}}{\sqrt{2}} & \frac{( {z}_{2} - {z}_{2}^{*} - {z}_{1} - {z}_{1}^{*} )}{2} & \frac{( {z}_{1} - {z}_{1}^{*} - {z}_{2} - {z}_{2}^{*} )}{2} \\ \frac{{z}_{3}^{*}}{\sqrt{2}} & - \frac{{z}_{3}^{*}}{\sqrt{2}} & \frac{( {z}_{1} - {z}_{1}^{*} + {z}_{2} + {z}_{2}^{*} )}{2} & \frac{- ( {z}_{1} - {z}_{1}^{*} - {z}_{2} - {z}_{2}^{*} )}{2}\end{matrix} )$$

where a star (*) refers to a complex conjugate and z₁, z₂, z₃ are three complex symbols to be transmitted.

In space-time coding, the most essential criteria in code selection are the achieved diversity, code rate and delay. Diversity can be described by the number of channels to be decoded independently, and for full diversity this means the same as the number of transmit antennas. The code rate is the ratio of space-time coded signal velocity to signal velocity that is coded only temporally. Delay, for its part, is the length of a space-time block. Depending on the modulation method used, either a term real coding or complex coding is used.

So far, all complex space-time block codes have belonged to two categories: a group based on real codes, halving the code rate, or a group based on square unitary matrices.

‘Open-loop diversity’ should have these four properties:

1. Full diversity in regard to the number of antennas.

2. Only linear processing is required in a transmitter and a receiver.

3. Transmission power is divided equally between the antennas.

4. The code rate efficiency is as high as possible.

A drawback of the above solutions is that only the requirements 1 and 2 can be fulfilled. For example, the transmission power of different antennas is divided unequally, i.e. different antennas transmit at different powers. This causes problems in the planning of output amplifiers. Furthermore, the code rate is not optimal.

As an example, the rate ¾ code for four transmit antennas with full diversity is given in the following formula:

$$( {z}_{1} , {z}_{2} , {z}_{3} ) -> ( \begin{matrix}{z}_{1} & {z}_{2} & {z}_{3} & 0 \\ - {z}_{2}^{*} & {z}_{1}^{*} & 0 & - {z}_{3} \\ - {z}_{3}^{*} & 0 & {z}_{1}^{*} & {z}_{2} \\ 0 & {z}_{3}^{*} & - {z}_{2}^{*} & {z}_{1}\end{matrix} ) . \qquad ( 1 )$$

In this code, the, zeros on the diagonal of the code matrix clearly indicate the imbalance of power.

### SUMMARY OF THE INVENTION

It is thus an object of the invention to implement a method and an arrangement by which a more optimal diversity is achieved with different numbers of antennas. This is achieved by a method of transmitting a digital signal consisting of symbols, the method comprising the steps of coding complex symbols to channel symbols in blocks of given length and transmitting the channel symbols via several different channels and two or more antennas, and in which method the coding is defined by a code matrix comprising an orthogonal block code.

In the method according to the invention, information is transmitted in redundant directions of the orthogonal code such that a code rate is higher than what is allowed by orthogonality.

The invention also relates to an arrangement for transmitting a digital signal consisting of symbols, which arrangement comprises means at the transmission end for coding complex symbols to channel symbols in blocks of given length, and the coding of the means is defined by a code matrix comprising an orthogonal block code, and means for transmitting the channel symbols via several different channels and two or more antennas.

The arrangement of the invention comprises the means for including information in redundant directions of the orthogonal code such that a code rate is higher than what is allowed by orthogonality.

The solution of the invention can provide a system in which any number of transmit and receive antennas can be used and full diversity gain can be achieved by means of space-time block coding.

In a solution according to a preferred embodiment of the invention, complex block codes are applied. In several prior art block codes the power balance is not the best possible, i.e. the transmission power of different antennas varies as a function of time. This is due to the natural inefficiency of the codes. The inefficiency of codes means that in code matrices representing each code there are redundant directions which are not used. In preferred embodiments of the invention these redundant directions are utilized by transmitting additional information, for example another space-time block code, in them. The transmission is continued in the redundant directions of the successive blocks until an entire block has been transmitted.

In a preferred embodiment of the invention, additional information is thus transmitted in the redundant directions of a space-time block code with a code rate lower than one. This additional information may be another space-time block code, for example. If the original block code is called a lower level code, this added code can be called an upper level code, although the codes as such can also be the same. By means of the addition, redundant directions can be reduced and the code rate can be made higher.

The upper layers naturally affect the orthogonality of a lower layer, which is why the linear decoding of the entire code by using one step is impossible. A two-level code can, however, be decoded by means of two linear steps: first the upper layer and then the lower layer. In order to achieve the best result, instead of linear decoding the upper layer can be decoded by means of an optimal configuration search.

A potential imbalance of a two-layer code can further be used for the transmission of a third layer etc. Thus, the linear coding of an /-level code is preferably performed by means of/steps, beginning with the outer layer. The interference caused by the outer layer to the lower layer is suppressed by the upper layer detection.

Let us examine the mathematical base of the preferred embodiments. Let us select a space-time block code for N transmit antennas and for the sake of clarity, for N symbol intervals. The orthogonality of the code matrix restricts the number of symbols to be K, wherein K≦N. Preferred embodiments of the invention can be applied when K<N. In such a case, antenna resources are used inefficiently, the code rate of the block code is lower than one and it is not power-uniformized.

The received symbol vector is a vector in an M×N-dimensional complex space which is to be called reception space. Here M is the number of receive antennas. In the following it is assumed for the sake of clarity that M=1. Now different conceptions of orthogonalities should be noticed. Firstly, there is a code matrix orthogonality, which relates to the possibility of linear decoding of a received signal and to full diversity. Secondly there is a conventional orthogonality in the reception space.

The code matrix orthogonal K symbols tune the K-dimensional subspace to the reception space, and this subspace can be called a block code reception subspace. Since K<N, i.e. the dimension of the reception space is larger than that of the block code reception subspace, the reception space has room for other information as well. This additional information can be called an upper layer. This room in the reception space comprises the directions that are redundant for the code matrix, i.e. orthogonal to the block code reception subspace in the reception space.

The orthogonality of the reception space is not analogous to the code matrix orthogonality, since the latter was already maximized in connection with the selection of K. Thus the linear decoding by using one step is not possible. However, the redundant directions can be decoded first and they can be subtracted from the rest of the signal by means of interference cancellation. Thereafter, the remaining signal can be decoded linearly because of the orthogonality of the code matrix.

If symbols are transmitted as such in the redundant directions, full diversity gain will not be achieved. The channels are combined incoherently. In order to avoid this, space-time block coding is utilized on the upper layer in a preferred embodiment such that outputs of the redundant directions in the successive blocks comprise the blocks of the block code. This upper level code can be decoded as a common block code. After the interference suppression, the same can be done for the lower level code.

If a block code with a code rate lower than one is used on the upper level, there is still redundancy, which means that the code rate of the layered code is still lower than one. This inefficiency in some preferred embodiments of the invention is utilized by adding the upper level code to the remaining redundant directions. This process can be repeated so many times as desired and the code rate one can thus be approached asymptotically.

In some other preferred embodiments of the invention, known pilot symbols, which improve channel estimation, are added to the uppermost layer (above other layers).

The solution of the invention provides a plurality of advantages. A code rate can be increased asymptotically towards the optimal value, i.e. one. A code rate can be made higher than is allowed by the orthogonality of the original lower level code. Even after the addition of additional information there can still be redundant directions in the code, and new additional information can further be transmitted in these directions etc. In addition, transmission power is divided equally between the antennas, because by suitably adding additional information, the power that is transmitted from each antenna is made equal at each moment of time. Also known pilot symbols which can be utilized can be transmitted as additional information. Further, by applying the solution of the invention such coding can preferably be used that allows the peak-to-average power or the average-to-minimum power to be minimized.

### BRIEF DESCRIPTION OF DRAWINGS

In the following the invention will be described in greater detail in connection with the preferred embodiments, with reference to the attached drawings, in which

FIG. 1 shows an example of a system according to an embodiment of the invention,

FIG. 2 shows another example of a system according to an embodiment of the invention,

FIG. 3 illustrates a two-layer code, and

FIG. 4 illustrates an example of an arrangement according to an embodiment of the invention.

### DETAILED DESCRIPTION OF PREFERRED EMBODIMENTS

The invention can be used in radio systems in which at least a part of a signal can be transmitted by using at least three or more transmit antennas or three or more beams that are provided by using any number of transmit antennas. A transmission channel can be formed by using a time division, frequency division or code division multiple access method, for example. Also systems that employ combinations of different multiple access methods are systems in accordance with the invention. The examples describe the use of the invention in a universal mobile communication system utilizing a broadband code division multiple access method implemented with a direct sequential technique, yet without restricting the invention thereto.

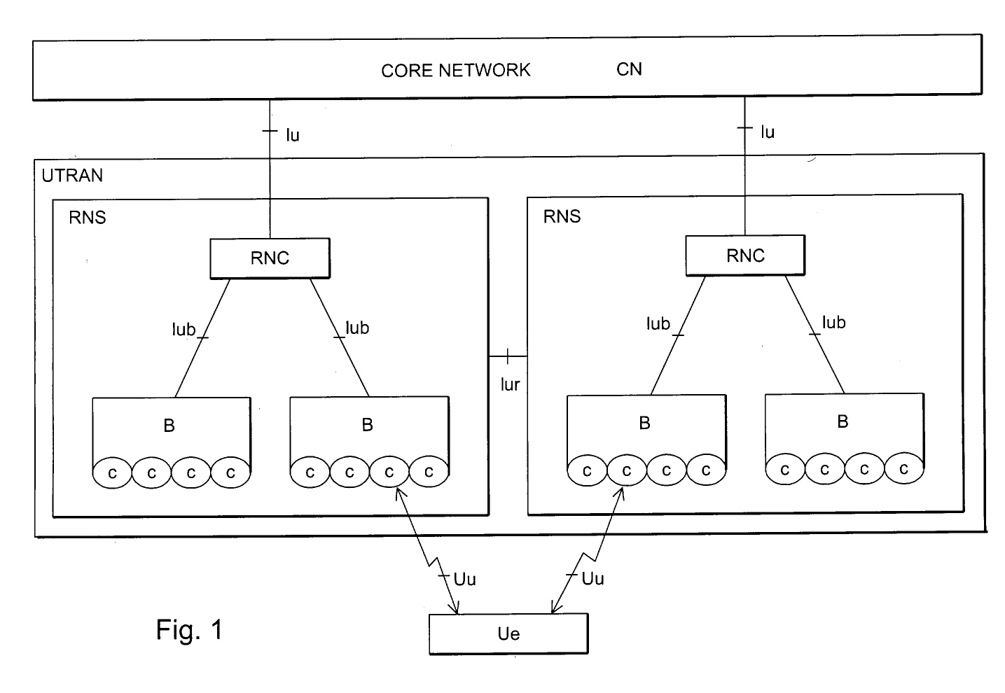

Referring to FIG. 1, a structure of a mobile communication system is described by way of example. The main parts of the mobile communication system are core network CN, UMTS terrestrial radio access network UTRAN and user equipment UE. The interface between the CN and the UTRAN is called Iu and the air interface between the UTRAN and the UE is called Uu.

The UTRAN comprises radio network subsystems RNS. The interface between the RNSs is called Iur. The RNS comprises a radio network controller RNC and one or more nodes B. The interface between the RNC and B is called Iub. The coverage area, or cell, of the node B is marked with C in the figure.

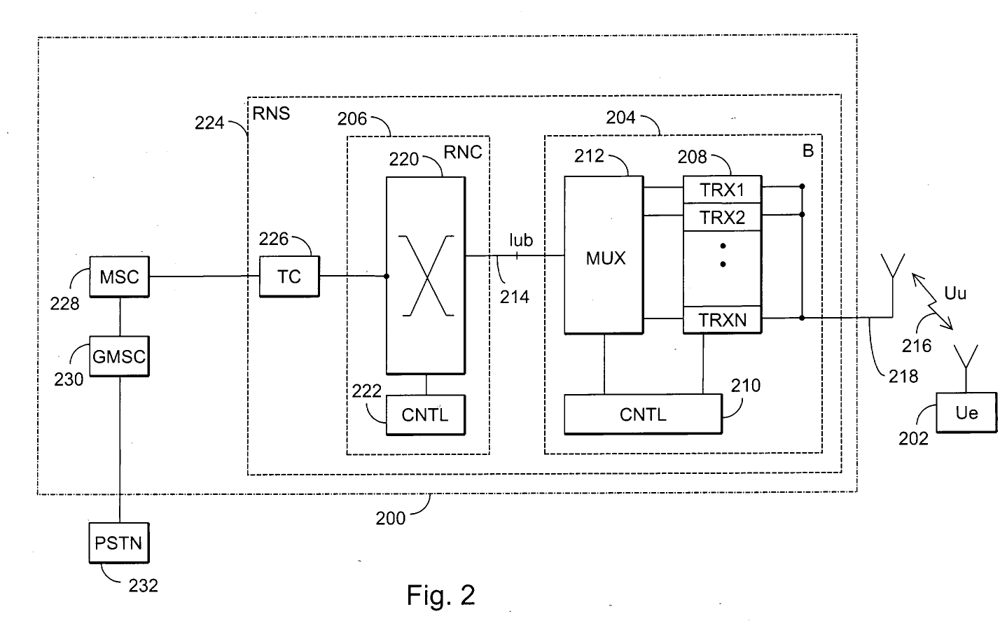

The description of FIG. 1 is relatively general, and it is clarified with a more specific example of a cellular radio system in FIG. 2. FIG. 2 includes only the most essential blocks, but it is obvious to a person skilled in the art that the conventional cellular radio system also includes other functions and structures, which need not be further explained herein. It is also to be noted that FIG. 2 only shows one exemplified structure. In systems according to the invention, details can be different from what are shown in FIG. 2, but as to the invention, these differences are not relevant.

A cellular radio network typically comprises a fixed network infrastructure, i.e. a network part 200, and user equipment 202, which may be fixedly located, vehicle-mounted or portable terminals. The network part 200 comprises base stations 204, a base station corresponding to the node B shown in the previous figure. A plural number of base stations 204 are, in turn, controlled in a centralized manner by a radio network controller 206 communicating with them. The base station 204 comprises transceivers 208 and a multiplexer unit 212.

The base station 204 further comprises a control unit 210 which controls the operation of the transceivers 208 and the multiplexer 212. The multiplexer 212 arranges the traffic and control channels used by several transceivers 208 to a single transmission connection 214, which forms an interface Iub.

The transceivers 208 of the base station 204 are connected to an antenna unit 218 which is used for implementing a bidirectional radio connection 216 to the user equipment 202. The structure of the frames to be transmitted in the bi-directional radio connection 216 is defined separately in each system, the connection being referred to as an air interface Uu.

The radio network controller 206 comprises a group switching field 220 and a control unit 222. The group switching field 220 is used for connecting speech and data and for combining signalling circuits. The base station 204 and the radio network controller 206 form a radio network subsystem 224 which further comprises a transcoder 226. The transcoder 226 is usually located as close to a mobile services switching centre 228 as possible, because speech can then be transferred in a cellular radio network form between the transcoder 226 and the radio network controller 206, which saves transmission capacity.

The transcoder 226 converts different digital speech coding forms used between a public switched telephone network and a radio network to make them compatible, for instance from a fixed network form to another cellular radio network form, and vice versa. The control unit 222 performs call control, mobility management, collection of statistical data and signalling.

FIG. 2 further shows the mobile services switching centre 228 and a gateway mobile services switching centre 230 which controls the connections from the mobile communications system to the outside world, in this case to a public switched telephone network 232.

The invention can thus be applied particularly to a system in which signal transmission is carried out by using ‘complex space-time block coding’ in which the complex symbols to be transmitted are coded to channel symbols in blocks having the length of a given K in order to be transmitted via several different channels and two or more antennas. These several different channels can be formed of different time slots. As a result of the coding, the symbol block forms into a code matrix in which the number of columns corresponds to the number of antennas to be used for the transmission and the number of rows corresponds to the number of different channels, which, in case of space-time coding, is the number of time slots to be used. Correspondingly, the invention can be applied to a system in which different frequencies or different spreading codes are used instead of time slots. In this case it does not naturally deal with space-time coding but rather with space-frequency coding or space-code-division coding. The space-frequency coding could be used in an OFDM (orthogonal frequency division multiplexing) system, for example.

### EXAMPLE

### Coding of Rate 15/16 Code

Let us next examine a preferred embodiment of the invention, wherein a space-time block code of a lower layer and an upper layer block code to be coded in redundant directions are similar 4×4 codes, and the code matrix of these two codes is the above matrix (1). A two-layer rate 15/16 code is thus obtained. By leaving out one column of the code matrix, a three-antenna version is obtained from this four-antenna code.

In a two-layer code the lowest layer comprises four basic blocks. Thus the processing delay equals to 16 symbol intervals. 15 complex symbols altogether can be coded to a two-layer code when three or four antennas are used.

The redundant direction of the code matrix (1) is tuned by the matrix

$${β}_{0} = ( \begin{matrix}0 & 0 & 0 & 1 \\ 0 & 0 & 1 & 0 \\ 0 & - 1 & 0 & 0 \\ - 1 & 0 & 0 & 0\end{matrix} ) \qquad ( 4 )$$

The matrix Po used in this example is by no means the only possible tuning matrix, but also other matrices can be used, as is obvious to a person skilled in the art. The described matrix provides the advantage that it provides the decoding with an orthogonal noise component.

The selection of the above matrix (4) can be explained in the following way. Let us define R=C(\overline{z})α+noise as a received symbol, when a conventional matrix (1) is used as a code matrix and α is a vector denoting the channel. For this R, the orthogonality of a block code reception subspace in the reception space in proportion to the reception subspace of the upper layer is:

α^{T}β₀R=0+noise. (5)

To construct the upper level code, zeros in the lower level code are filled with block code rows of the upper level. The upper level matrix, which replaces the zeros in the lower level matrix, is formed of the code matrix (1) and the redundancy matrix β₀ (4):

$${C}^{( 2 )} = ( \begin{matrix}{z}_{13} & {z}_{14} & {z}_{15} & 0 \\ - {z}_{14}^{*} & {z}_{13}^{*} & 0 & - {z}_{15} \\ - {z}_{15}^{*} & 0 & {z}_{13}^{*} & {z}_{14} \\ 0 & {z}_{15}^{*} & - {z}_{14}^{*} & {z}_{13}\end{matrix} ) . \qquad ( 7 )$$

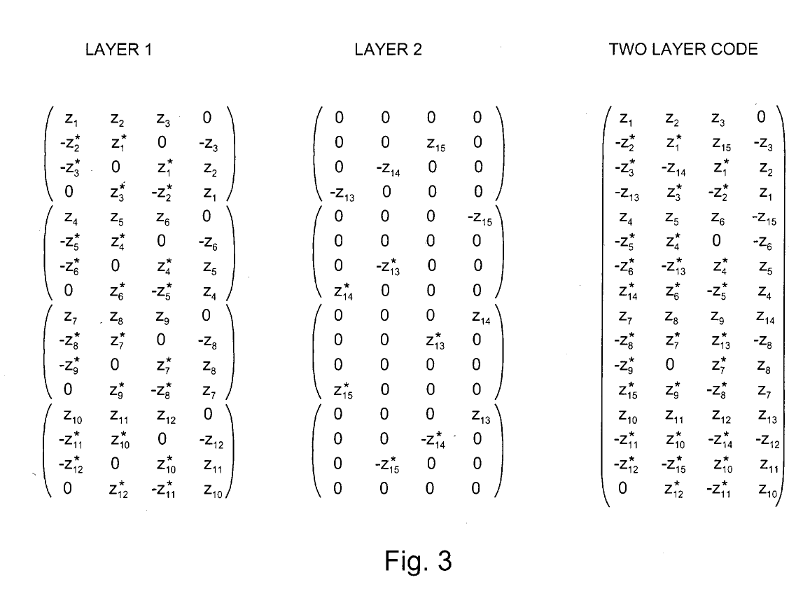

A matrix, which is constructed from the product of the redundancy matrix β₀ and such a matrix that has one row of the matrix (7) on its diagonal, is added to each sub-block of the lower layer. The resulting two-layer block code is shown in FIG. 3. The first column of FIG. 3 includes the code of the first layer, the second column includes the code of the second layer and the third column includes the two-layer code.

The two-layer code further comprises some zeros. Either known pilot symbols or a code matrix row of the third layer block code can, if desired, be placed to the table of FIG. 3 to replace these zeros. By repeating this four times for each block of the third layer, a three-layer rate 63/64 code is obtained for four transmit antennas.

By repeating the addition procedure further for the 63/64 code, a four-layer rate 255/256 code is obtained for four antennas with a processing delay 256, and further a five-layer rate 1023/1024 code for four antennas with a processing delay 1024 and finally an /-layer rate 1-2^{-2/} four-antenna code with a processing delay 2^{2/}. The corresponding three-antenna codes are obtained by leaving out one column.

Finally, if desired, known pilot symbols can be used for replacing the remaining zeros. Thus the code becomes completely power-uniformized.

### EXAMPLE

### Decoding of Rate 15/16 Code

Let us next examine a decoding method which can be applied to the reception of signals that are coded by using the above manners. An example of decoding the signal of one antenna is given herein, but the method can be employed for more antennas as well.

The optimal decoding should comprise a configuration search of the upper level. Thus, in case of the two-layer code of FIG. 3, for instance, the optimal decoding comprises the steps of going through all 4³, i.e. 64, symbol combinations of the upper layer, deleting them from the received signals of the lower layer and decoding the lower layer and searching the combination that minimizes the Euclidean distance of the used metric to the detected signal. The optimal decoding is not sensitive to channel variations between the successive blocks of the lowest layer, whereupon a multiple layer code is as sensitive to the fading speed as the block code of the lowest layer.

Let us first examine the decoding of the lowest layer, which can be performed in accordance with the prior art, provided that the interferences of the upper layers are suppressed. The maximum likelihood detection metric of the 4×4 block code according to the matrix (1) for the kth transmitted symbol zₖ is:

Mₖ=|Tr(βₖ+αR^{H}+Rα^{H}β^{H}ₖ₋)−zₖ|²+(Tr(α^{H}α)−1)|zₖ|² (8)

where Tr refers to a matrix trace, i.e. the sum of the diagonal elements, H refers to the transpose of the complex conjugate, α is a channel weight matrix, R is the matrix of the received symbols, and the decoding matrices are:

$$\begin{matrix}{β}_{1 -} = ( \begin{matrix}1 & 0 & 0 & 0 \\ 0 & 0 & 0 & 0 \\ 0 & 0 & 0 & 0 \\ 0 & 0 & 0 & 1\end{matrix} ) , {β}_{2 -} = ( \begin{matrix}0 & 1 & 0 & 0 \\ 0 & 0 & 0 & 0 \\ 0 & 0 & 0 & 1 \\ 0 & 0 & 0 & 0\end{matrix} ) , {β}_{3 -} = ( \begin{matrix}0 & 0 & 1 & 0 \\ 0 & 0 & 0 & - 1 \\ 0 & 0 & 0 & 0 \\ 0 & 0 & 0 & 0\end{matrix} ) \\ {β}_{1 +} = ( \begin{matrix}0 & 0 & 0 & 0 \\ 0 & 1 & 0 & 0 \\ 0 & 0 & 1 & 0 \\ 0 & 0 & 0 & 0\end{matrix} ) , {β}_{2 +} = ( \begin{matrix}0 & 0 & 0 & 0 \\ - 1 & 0 & 0 & 0 \\ 0 & 0 & 0 & 0 \\ 0 & 0 & - 1 & 0\end{matrix} ) , {β}_{3 +} = ( \begin{matrix}0 & 0 & 0 & 0 \\ 0 & 0 & 0 & 0 \\ - 1 & 0 & 0 & 0 \\ 0 & 1 & 0 & 0\end{matrix} ) .\end{matrix}$$

The aim is to minimize this metric, which means that the metric is used as a criterion for deciding which symbol zₖ comprises.

Let us next examine the iterative interference suppression procedure for the two-layer code of FIG. 3, the procedure converging towards the optimal decoding.

The term αₙ denotes a complex channel weight between the nth transmit antenna and the receive antenna. Thus, the channel vector for a four-antenna transmission is α=(α₁, α₂, α₃, α₄). The 4×4 blocks of the two-layer code, which correspond to the lower layer blocks, are marked with C(\overline{z})_{2-layer,m}, m=1, 2, 3, 4. Correspondingly, the received symbols in the sixteen intervals that are covered by the code can be divided into four groups:

ₘR=C(\overline{z})_{2-layer,m} α+noise, m=1, 2, 3, 4. (9)

To be exact, the received symbols are:

$$\begin{matrix}{}_{1} R = ( \begin{matrix}{α}_{1} {z}_{1} + {α}_{2} {z}_{2} + {α}_{3} {z}_{3} \\ {α}_{2} {z}_{1}^{*} - {α}_{1} {z}_{2}^{*} - {α}_{4} {z}_{3} + {α}_{3} {z}_{15} \\ {α}_{3} {z}_{1}^{*} + {α}_{4} {z}_{2} - {α}_{1} {z}_{3}^{*} - {α}_{2} {z}_{14} \\ {α}_{4} {z}_{1} - {α}_{3} {z}_{2}^{*} + {α}_{2} {z}_{3}^{*} - {α}_{1} {z}_{13}\end{matrix} ) + noise & ( 10 ) \\ {}_{2} R = ( \begin{matrix}{α}_{1} {z}_{4} + {α}_{1} {z}_{5} + {α}_{3} {z}_{6} - {α}_{4} {z}_{15} \\ {α}_{2} {z}_{4}^{*} - {α}_{1} {z}_{5}^{*} - {α}_{4} {z}_{6} \\ {α}_{3} {z}_{4}^{*} + {α}_{4} {z}_{5} - {α}_{1} {z}_{6}^{*} - {α}_{2} {z}_{13} \\ {α}_{4} {z}_{4} - {α}_{3} {z}_{5}^{*} + {α}_{2} {z}_{6}^{*} + {α}_{1} {z}_{14}\end{matrix} ) + noise & ( 11 ) \\ {}_{3} R = ( \begin{matrix}{α}_{1} {z}_{7} + {α}_{2} {z}_{8} + {α}_{3} {z}_{9} + {α}_{4} {z}_{14} \\ {α}_{2} {z}_{7}^{*} - {α}_{1} {z}_{8}^{*} - {α}_{4} {z}_{9} + {α}_{3} {z}_{13}^{*} \\ {α}_{3} {z}_{7}^{*} + {α}_{4} {z}_{8} - {α}_{1} {z}_{9}^{*} \\ {α}_{4} {z}_{7} - {α}_{3} {z}_{8}^{*} + {α}_{2} {z}_{9}^{*} + {α}_{1} {z}_{15}\end{matrix} ) + noise & ( 12 ) \\ {}_{4} R = ( \begin{matrix}{α}_{1} {z}_{10} + {α}_{2} {z}_{11} + {α}_{3} {z}_{12} + {α}_{4} {z}_{13} \\ {α}_{2} {z}_{10}^{*} - {α}_{1} {z}_{11}^{*} - {α}_{4} {z}_{12} - {α}_{3} {z}_{14}^{*} \\ {α}_{3} {z}_{10}^{*} + {α}_{4} {z}_{11} - {α}_{1} {z}_{12}^{*} - {α}_{2} {z}_{15}^{*} \\ {α}_{4} {z}_{10} - {α}_{3} {z}_{11}^{*} + {α}_{2} {z}_{12}^{*}\end{matrix} ) + noise . & ( 13 )\end{matrix}$$

After the interference caused by the upper layer symbols is (partly) suppressed, each of these sub-blocks can be decoded as 4×4 blocks in the form of the matrix (1) by using the metric of the equation (8).

On the other hand, when the interference is suppressed from the lowest layer, the equations (10 to 13) show that each received signal comprises information on only one upper level symbol multiplied by the channel. The maximum rate combination can be performed for them by multiplying them by a suitable channel estimate.

As a basis for iterative interference suppression in case of slowly fading channels, linear /-step decoding can be used, which is described in the following. In fast fading channels, the iterations should be started by detecting the lowest layer without interference suppression.

Let us next examine linear /-step decoding, i.e. a detection and interference suppression method, whereby the previously described /-layer code is decoded by using/linear steps. It is assumed that the channels are almost static over the code processing time 2^{2/}.

In addition to the estimated channel, a vector of the squared channels α⁽²⁾=(α₁²,α₂²,α₃²,α₄²) as well as a vector of the fourth powers of the channel α⁽⁴⁾=(α₁⁴,α₂⁴,α₃⁴,α₄⁴) for the /-layer code and a vector of the 2/-2th powers of the channel

$${α}^{( 2 l - 2 )} = ( {α}_{1}^{2 l - 2} , {α}_{2}^{2 l - 2} , {α}_{3}^{2 l - 2} , {α}_{4}^{2 l - 2} )$$

are required.

First the two-layer code of FIG. 3 is decoded.

The pseudo-received symbol of the second layer can be constructed from each set ₘR of four received symbols in the equations (10 to 13),

Rₘ⁽²⁾=−α^{T}β_{0 m}R. (14)

T refers to a transpose. This equation is a good illustration of the elimination of the information, which is coded in the redundant directions of the code matrix, from the received signal.

The pseudo-received symbols according to the equation (14) comprise the information of the first four blocks, the information being coded in the redundant directions of the first layer. The vector of these pseudo-received symbols has the form

$${R}^{( 2 )} = ( \begin{matrix}{α}_{1}^{2} {z}_{13} + {α}_{2}^{2} {z}_{14} + {α}_{3}^{2} {z}_{15} \\ {α}_{2}^{2} {z}_{13}^{*} - {α}_{1}^{2} {z}_{14}^{*} - {α}_{4}^{2} {z}_{15} \\ {α}_{3}^{2} {z}_{13}^{*} + {α}_{4}^{2} {z}_{14} - {α}_{1}^{2} {z}_{15}^{*} \\ {α}_{4}^{2} {z}_{13} - {α}_{3}^{2} {z}_{14}^{*} + {α}_{2}^{2} {z}_{15}^{*}\end{matrix} ) + noise . \qquad ( 15 )$$

The metric according to the equation (8) can now be applied to decode the symbols z₁₃, z₁₄ and z₁₅. The metric is illustrated by the formula

Mₖ⁽²⁾=|R^{(2)H}βₖ+α⁽²⁾+α^{(2)H}β^{H}ₖ₋R⁽²⁾−zₖ|²+(α^{(2)H}α⁽²⁾−1)|zₖ|² (16)

which gives the estimate z₁₂₊ₖ, when the decoding matrices β_{k±} that were described after the equation (8) are used.

These estimates should now be subtracted from the received symbols. To minimize the interference, MAP (maximum a posteriori) estimates, for instance, can be calculated for the transmitted upper layer symbols {∃₁₃, ∃₁₄, ∃₅} and for the upper layer code matrix (7)

$${( 2 )}^{} = ( \begin{matrix}{13}_{} & {14}_{} & {15}_{} & 0 \\ - {14}_{*}^{} & {13}_{*}^{} & 0 & - {15}_{} \\ - {15}_{*}^{} & 0 & {13}_{*}^{} & {14}_{} \\ 0 & {15}_{*}^{} & - {14}_{*}^{} & {13}_{}\end{matrix} ) . \qquad ( 17 )$$

If matrices, which have rows of this matrix (17) on their diagonal, are marked with the term

$${m}_{( 2 , diag )}^{} , m = 1 , 2 , 3 , 4$$

the interference can be suppressed from the four successive received symbols in the equation (9):

$${}_{m} \overline{R} = {}_{m} R - {β}_{0} {C}_{m}^{∃ ( 2 , diag )} α . \qquad ( 18 )$$

These interference-suppressed blocks ₘR can be decoded in accordance with the prior art as space-time block codes similarly as in the equation (8). It should be taken into account that interference only occurs in one direction: the symbols of the upper layer interfere with the lower layer, but not vice versa.

For codes with three or more layers, the above described procedure is repeated iteratively equivalent times, always starting from the uppermost level.

Thus, if a three-layer rate 63/64 code is examined, the received 64 symbols are first divided into 16 blocks, each comprising four symbols, ₘR, m=1, 2, . . . , 16. The pseudo-received symbols Rₘ⁽²⁾ of the second layer are formed from each of these blocks as in the equation (14). These symbols are collected to four blocks of four symbols ₙR⁽²⁾, n=1, . . . , 4. Each of these blocks has the same form as the equation (15) added by the third layer interference.

The pseudo-received symbol of the third layer can be constructed from each set ₙR⁽²⁾ of four pseudo-received symbols of the second layer,

Rₙ⁽³⁾=−α^{(2)T}β_{0 n}^{R}⁽²⁾. (19)

The information is coded in the redundant directions of the four second layer blocks, and each second layer block further consists of four first layer blocks. The vector of the pseudo-received symbols is now

$${R}^{( 3 )} = ( \begin{matrix}{α}_{1}^{4} {z}_{61} + {α}_{2}^{4} {z}_{62} + {α}_{3}^{4} {z}_{63} \\ {α}_{2}^{4} {z}_{61}^{*} - {α}_{1}^{4} {z}_{62}^{*} - {α}_{4}^{4} {z}_{63} \\ {α}_{3}^{4} {z}_{61}^{*} + {α}_{4}^{4} {z}_{62} - {α}_{1}^{4} {z}_{63}^{*} \\ {α}_{4}^{4} {z}_{61} - {α}_{3}^{4} {z}_{62}^{*} + {α}_{2}^{4} {z}_{63}^{*}\end{matrix} ) + noise . \qquad ( 20 )$$

This, in turn, can be decoded by means of a conversion of the equation (8):

Mₖ⁽³⁾=|R^{(3)H}βₖ+α⁽⁴⁾+α^{(4)H}β^{H}ₖ₋R⁽³⁾^{-z}ₖ|²+(α^{(4)H}α⁽⁴⁾−1)|zₖ|² (21)

which gives an estimate z₆₀₊ₖ, when the decoding matrices β_{k±} described after the equation (8) are used.

These estimates can be subtracted from the pseudo-received symbols, which were collected to blocks ₙR⁽²⁾, of the second layer. After suppressing interference from the third layer, each of these blocks can be decoded by means of the metric of the equation (16) and, after suppressing interference from the second layer, sixteen first layer blocks can be decoded by using the metric (8).

In a similar manner, a code comprising/layers can be decoded, thereby taking into account that when the pseudo-received symbols of the /th layer are constructed, the term α^{(2/-2)} is used as a channel vector in the equations (14, 18) and when the metric of the Ith layer is calculated according to the equations (16, 21), the term α^{(2/-1)} is used as a channel vector.

### EXAMPLE

### Rate 1 Codes

The code rate of a layered code can be made higher when the code to be used for an upper layer is different than that of a lower layer, compared with the situation where the same code is used for all layers. A disadvantage is, however, that the performance impairs due to the incoherent combination of upper layer channels.

Let us first examine a space-time block code that is transmitted by four antennas, has a code rate 1 and full diversity and that only uses four symbol periods. This means that the code provides the errors of one symbol with quadruple diversity, i.e. each symbol is transmitted from each antenna at a moment of time, and at each moment of time from an antenna. The four complex symbols that are coded to a code matrix are marked with zᵢ, i=1, . . . , 4. In a solution according to a preferred embodiment, the code matrix is selected such that at least two of these symbols form an orthogonal code, and two other symbols are coded in the redundant directions of this orthogonal code.

Power-uniformized codes for continuous amplitude modulation can be constructed such that a signal transmitted from each antenna has a continuous power envelope. The matrix elements in the code matrices of such codes are only dependent on one modulation symbol. A power-uniformized full rate code can be constructed from matrices of the following form, for instance:

$$[ \begin{matrix}° & * & • & ♦ \\ * & ° & ♦ & • \\ • & ♦ & ° & * \\ ♦ & • & * & °\end{matrix} ] or [ \begin{matrix}° & * & • & ♦ \\ * & ° & ♦ & • \\ • & ♦ & * & ° \\ ♦ & • & ° & *\end{matrix} ] .$$

Here the symbols °, *, •, ⋄ mean that the corresponding matrix element depends on one symbol or its complex conjugate. Further, in case of continuous envelope symbols, all matrix elements have the same norm. This is due to the requirement for full diversity. Thus, any ° is a phase vector multiplied by zₖ* or zₖ* etc. It is to be noted that in this kind of coding, ‘germinal matrices’, i.e. the matrix parts that depend only on one symbol are unitary matrices.

Any power-uniformized four-antenna code with a full code rate and diversity can be brought to a form of either one of the above mentioned matrices by using discrete matrix operations (changing places of rows and columns, for instance). These operations do not affect the code performance. Also general unitary conversions can be applied from right and/or left. The power spectrum changes but otherwise the performance remains the same.

An example of this is a code in which three symbols are coded orthogonally and one symbol is coded on an upper level without a code, in which case the code matrix is, for example, as follows:

$$( {z}_{1} , {z}_{2} , {z}_{3} , {z}_{4} ) -> ( \begin{matrix}{z}_{1} & {z}_{2} & {z}_{3} & {z}_{4} \\ - {z}_{2}^{*} & {z}_{1}^{*} & {z}_{4} & - {z}_{3} \\ - {z}_{3}^{*} & - {z}_{4} & {z}_{1}^{*} & {z}_{2} \\ - {z}_{4} & {z}_{3}^{*} & - {z}_{2}^{*} & {z}_{1}\end{matrix} ) . \qquad ( 23 )$$

Instead of the zeros of the original one-layer code, one symbol z₄ is transmitted. The two-step linear decoding for this code begins with creating a pseudo-received symbol of the second layer, as in the equation (14), then making a symbol decision for z₄ by means of this pseudo-received symbol, and subtracting the interference from the lower level, i.e. from the symbols z₁, z₂, z₃, and finally decoding them as a normal block code.

The optimal decoding comprises a separate lower level decoding by using the metric of the equation (8) for each of the four possible upper level (z₄) configurations and selecting the one that minimizes the Euclidean distance of the used metric to the detected signal, or just by searching 4⁴=256 configurations of the entire code to find the optimal alternative.

A better performance (with double delay) is achieved by a two-layer rate 1 code, whereby the full rate code 2×2 is used as an upper code

$$( {z}_{1} , {z}_{2} ) \to ( \begin{matrix}{z}_{1} & {z}_{2} \\ - {z}_{2}^{*} & {z}_{1}^{*}\end{matrix} ) .$$

Thus, eight complex symbols are coded for example in the following manner:

$$( {z}_{1} , {z}_{2} , {z}_{3} , {z}_{4} , {z}_{5} , {z}_{6} , {z}_{7} , {z}_{8} ) -> ( \begin{matrix}{z}_{1} & {z}_{2} & {z}_{3} & {z}_{8} \\ - {z}_{2}^{*} & {z}_{1}^{*} & {z}_{8} & - {z}_{3} \\ - {z}_{3}^{*} & - {z}_{7} & {z}_{1}^{*} & {z}_{2} \\ - {z}_{7} & {z}_{3}^{*} & - {z}_{2}^{*} & {z}_{1} \\ {z}_{4} & {z}_{5} & {z}_{6} & {z}_{7}^{*} \\ - {z}_{5}^{*} & {z}_{4}^{*} & {z}_{7}^{*} & - {z}_{6} \\ - {z}_{6}^{*} & {z}_{8}^{*} & {z}_{4}^{*} & {z}_{5} \\ {z}_{8}^{*} & {z}_{6}^{*} & - {z}_{5}^{*} & {z}_{4}\end{matrix} ) . \qquad ( 24 )$$

A two-step linear decoding for this code begins with dividing the eight received symbols into two groups of four symbols, and by forming the pseudo-received symbols in each group according to the equation (14). They are decoded analogously as a 2×2 block code in a squared channel α⁽²⁾=(α₁²,α₂²,α₃²,α₄²), as in the case of the rate 15/16 code. The interference is suppressed from two lower level codes, and they are decoded as common 4×4 block codes by using the metric of the equation (8).

The optimal decoding comprises the steps of searching 16 upper level configurations, suppressing the interference caused by them, decoding the lower level by means of the metric of the equation (8) and selecting the configuration that minimizes the Euclidean distance of the used metric to the detected signal.

### EXAMPLE

### Arrangement

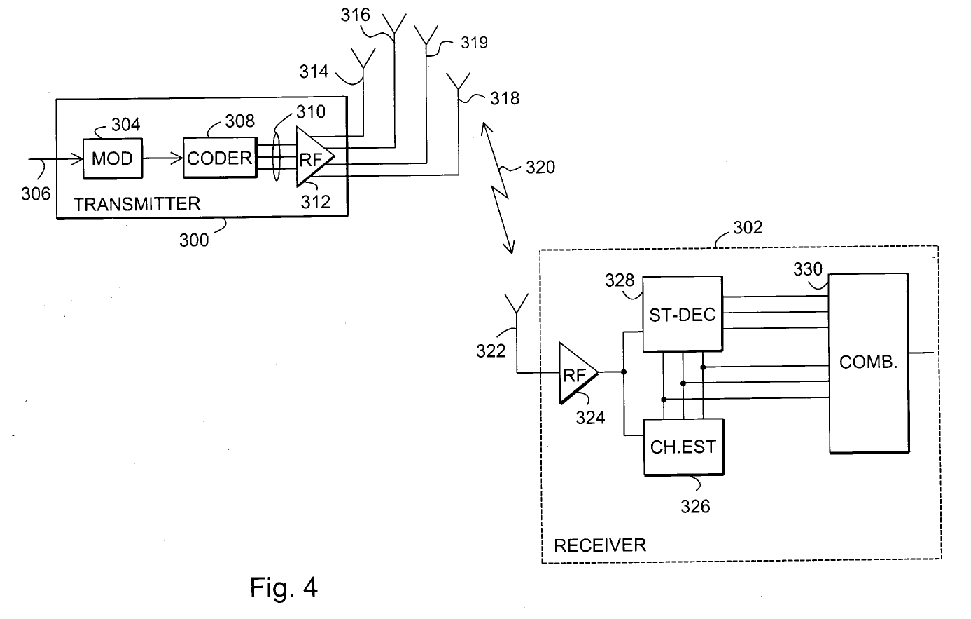

FIG. 4 illustrates an example of a system according to an embodiment of the invention. The figure shows a situation where channel-coded symbols are transmitted via four antennas at different frequencies, in different time slots or by using a different spreading code. Firstly, the figure shows a transmitter 400, which is in connection with a receiver 402. The transmitter comprises a modulator 404 which receives as input a signal 406 to be transmitted, which consists of bits in a solution according to a preferred embodiment of the invention. The bits are modulated to symbols in the modulator. The symbols to be transmitted are grouped into blocks having the length of a given K. It is assumed in this example that the length of the block is three symbols. The symbols are conveyed to a coder 408. It is assumed that a two-layer code of the code rate 15/16 is used herein. Then the code matrix is, for example, as shown in FIG. 3. Channel symbols 410 are conveyed via radio frequency parts 412 to four antennas 414 to 419 in this example, wherefrom they are to be transmitted. The coder can preferably be implemented by means of a processor and suitable software or alternatively by means of separate components.

Let us examine the receiver shown in FIG. 4 once more. By means of the transmitter of the invention, a signal 420 is transmitted by using three or more antennas. The signal is received in the receiver 402 by means of an antenna 422 and it is conveyed to the radio frequency parts 424. The number of antennas in the receiver is not relevant for the invention. In the radio frequency parts the signal is converted to an intermediate frequency or to baseband. The converted signal is conveyed to a channel estimator 426, which forms estimates for the channel through which the signal has propagated. The estimates can be formed, for example, by means of previously known bits the signal contains, such as a pilot signal or a training sequence code. The signal is conveyed from the radio frequency parts also to a combiner 428, to which also the estimates are delivered from the channel estimator 426. The channel estimator and the radio frequency parts can be implemented by employing the known methods.

The combiner 428 receives the symbols transmitted in different time slots, typically stores them temporarily in a buffer memory and forms estimates for the original block symbols by means of the channel estimates and the above described decoding method. A detector 430 performs the symbol detection. The signal is conveyed from the detector 430 further to the other parts of the receiver. The combiner and the detector can preferably be implemented by means of a processor and suitable software or alternatively by means of separate components.

Only one example of a possible receiver is described above. The calculation and use of channel estimates, for example, can be implemented in various other ways, as is obvious to a person skilled in the art.

Although the invention has been described above with reference to the examples according to the attached drawings, it is obvious that the invention is not restricted thereto, but may be modified in a variety of ways within the scope of the attached claims.

1. A method of transmitting a digital signal consisting of symbols, the method comprising:
coding complex symbols to channel symbols in blocks of given length wherein the coding is defined by a code matrix comprising an orthogonal block code,
including information in redundant directions of the orthogonal code such that a code rate is higher than what is allowed by orthogonality,
transmitting the signal via several different channels and two or more antennas.

2. A method as claimed in claim 1, wherein the information to be transmitted in the redundant directions is coded by a block code.

3. A method as claimed in claim 2, wherein the information to be transmitted in the redundant directions and the information to be transmitted in other directions are coded by a similar block code.

4. A method as claimed in claim 2, wherein the information to be transmitted in the redundant directions and the information to be transmitted in other directions are coded by a different block code.

5. A method as claimed in claim 1, wherein the information to be transmitted in the redundant directions is information that is not channel-coded.

6. A method as claimed in claim 2, wherein the block coding of the information to be transmitted in the redundant directions is performed in several successive blocks of the block code of the information to be transmitted in other directions.

7. A method as claimed in claim 1 or 2, wherein the information to be transmitted in the redundant directions is transmitted in zero points of the code matrix of the information to be transmitted in other directions.

8. A method as claimed in claim 2, wherein other coded information is transmitted in the redundant directions that have remained after the addition of an upper level block code.

9. A method as claimed in claims 2, wherein known pilot symbols are transmitted in the redundant directions that have remained after the addition of the information to be transmitted in the redundant directions.

10. A method as claimed in claim 2, wherein in signal decoding, the information transmitted in the redundant directions is decoded first and the information transmitted in other directions is decoded next.

11. A method as claimed in claim 10, wherein, before the decoding, the interference caused by the information transmitted in the redundant directions is suppressed from the information transmitted in other directions.

12. A method as claimed in claims 2, wherein the code matrix comprises parts that depend on only one symbol, and that these parts are unitary matrices.

13. An arrangement for transmitting a digital signal consisting of symbols, which arrangement comprises
means at the transmission end for coding complex symbols to channel symbols in blocks of given length, the coding being defined by a code matrix comprising an orthogonal block code,
means for including information in redundant directions of the orthogonal code such that a code rate is higher than what is allowed by orthogonality and
means for transmitting the signal via several different channels and two or more antennas.

14. An arrangement as claimed in claim 13, the arrangement comprising means for coding the information to be transmitted in the redundant directions by a block code.

15. An arrangement as claimed in claim 14, the arrangement comprising means for coding the information to be transmitted in the redundant directions and the information to be transmitted in other directions by a similar block code.

16. An arrangement as claimed in claim 14, the arrangement comprising means for coding the information to be transmitted in the redundant directions and the information to be transmitted in other directions by a different block code.

17. An arrangement as claimed in claim 14, the arrangement comprising means for including known pilot symbols in the redundant directions that have remained after the addition of the block code of the information to be transmitted in the redundant directions.

18. An arrangement as claimed in claim 13, the arrangement further comprising means at the reception end for decoding the information transmitted in the redundant directions first and the information transmitted in other directions next.

19. An arrangement as claimed in claim 18, the arrangement comprising means at the reception end for suppressing the interference caused by the information transmitted in the redundant directions from the information transmitted in other directions, before the decoding is performed.
